(19) United States
(12) Patent Application Publication
(10) Pub. No.: US 2003/0233667 A1
(43) Pub. Date: Dec. 18, 2003

(54) Method and apparatus for implementing a scaled upgrading of an upgradeable set-top box

(75) Inventors: Jose Rizalde M. Umipig, Quezon City (PH); Homer G. Bertol, De Castro Pasig City (PH); Joseph M. Arguelles, St. Makati City (PH)

Correspondence Address: STERNE, KESSLER, GOLDSTEIN & FOX PLLC, 1100 NEW YORK AVENUE, N.W., WASHINGTON, DC, 20005, US

(73) Assignee: ABS-CBN Broadcasting Corporation

(21) Appl. No.: 10/171,675

(22) Filed: Jun. 17, 2002

(51) Int. Cl. H04N 7/16; H04N 7/20; H04N 7/173

(52) U.S. Cl. 725/152; 725/68; 725/105

(57) ABSTRACT

An upgradeable set-top box for converting a signal is provided. The upgradeable set-top box is provided with a housing, including an input port for receiving an input signal, an output port for transmitting an output signal, an upgrade slot formed within a first side of the housing, and an expansion port. The upgradeable set-top box is further provided with a tuner for converting the input signal to an output signal. An upgrade module formed to removably fit within the upgrade slot, and an expansion box, removably attachable to the housing, provide for scaled upgrading of the functionality of the upgradeable set-top box. Basic functions of a digital receiver are initially incorporated in the upgradeable set-top box. Next, an upgrade module is joined to the upgradeable set-top box to allow a next stage upgrade. The next-stage upgrade will provide additional functions to the upgradeable set-top box such as standard television tuner and remote control capability. Finally, an expansion box can be attached to the upgradeable set-top box and upgrade module to provide further expansion of the functionality of the set-top box.

### BACKGROUND OF THE INVENTION

1. Field of the Invention

This invention relates to broadband communications systems involving both terrestrial and satellite digital television transmission and digital cable television transmission.

2. Background Art

Digital television transmission technology shall be the de-facto transmission format in the very near future. In the United States, more and more stations are converting to the digital format of transmission to take advantage of the clarity of reception and to make use of the wide pipeline made available to distribute information which includes video, sound, and data. Transmission of digital visual and aural signals can be made via terrestrial systems or cable/broadband systems. Digital set-top boxes are used to receive the signals and subsequently provide output signals to an attached television receiver or stereo system.

In developing countries, however, the high cost of existing digital set-top boxes makes them too expensive for the majority of the viewing public. Such digital boxes have been originally designed to cater to customers in highly developed countries hence, additional “bells and whistles” or add-on features are typically included in the design to maximize its use inside the home. These features may include but are not limited to electronic program guides and internal memory to provide pausing and limited rewind functions, all for the convenience of the viewer. However, all these features add more costs in manufacturing the box and inevitably lead to a more expensive set-top box for the consumers. To this end, basic set-top boxes have been made available to viewers.

Generally, basic set-top boxes are designed with only the minimum circuitry needed to receive digitally formatted transmissions. While these basic set-top boxes satisfy the immediate need to deliver digital television signals at the most cost-effective method, their usefulness is lost as the entertainment and information needs of the viewer become more sophisticated. More to the point, when viewers wish to take advantage of the additional features available through broadband communications, they are typically required to replace their basic set-top box with a more sophisticated appliance. Consequently, the investment made in purchasing the basic set-top box is lost.

There is, therefore, a need for a set-top box whose features may be upgraded and expanded over time. In this way, features can be initially removed from the basic set-top to bring the cost of the box down to its barest minimum. As the financial resources of the viewer increase and his entertainment and information needs become more sophisticated, the set-top box can be upgraded and expanded, thereby avoiding the loss of the initial investment made in the set-top box.

### BRIEF SUMMARY OF THE INVENTION

In an embodiment, the invention includes a method and apparatus for an upgradeable set-top box that provides for the reception of digital television signals conforming to either the Digital Video Broadcasting (DVB) or Advanced Television System Committee (ATSC) method of digital transmission. The upgradeable set-top box of the present invention is further able to receive standard television signals conforming to National Television Standards Committee (NTSC), Phase Alternation Line (PAL) or Sequential Couleur avec Memoire (SECAM) color systems. Still further, in an embodiment, the present invention is able to provide the following services: cable telephony, cable modem, web-based internet-over-TV, multi-channel digital audio, and prepaid options for the above-mentioned services.

In specific terms, the invention enables the reception of digital television signals from a digital television source that can be categorized as a terrestrial, satellite or broadband (cable television) broadcaster. In accordance with embodiments of the present invention, an upgradeable set-top box is connected to an aerial antenna which will receive the digital terrestrial signals from the broadcaster and in turn converts the received digital signals into standard NTSC, PAL, or SECAM RF signals or composite video signals ready to be fed to a standard compatible television receiver or monitor. In this way, the upgradeable set-top box provides digital receiver functionality to existing television sets hence lowering the cost of digital television reception.

As the capability of the viewer to spend increases, the upgradeable set-top box can be upgraded with the addition of an upgrade module. Once the upgrade module is added, the upgradeable set-top box can be appropriately viewed as an upgraded set-top box. The upgrade module provides additional features to the set-top box. For example, in an embodiment, the upgrade module provides remote tuning capability to the upgraded set-top box. The choice of channels to be viewed shall be fully controlled from a universal remote control. This would eliminate the use of separate controls for each different device.

In another embodiment, the upgrade module provides the capability for the upgraded set-top box to be connected to a cable television system. When the viewer enrolls in a subscription cable television service, the upgraded set-top box is “cable ready,” hence no additional set-top converter is required. In accordance with this embodiment, internal circuitry in the upgraded set-top box shall have integrated A/B switch functionality so that viewers can switch from terrestrial digital/analog transmissions or cable television reception.

In yet another embodiment, a prepaid section is incorporated in the upgrade module to provide prepaid card functionality to the upgraded set-top box. This would enable the reception of digital pay channels that are also transmitted together with the free-to-air digital signals. With digital transmission, more than two standard definition channels can be received by the upgraded set-top box. Thus, the extra pay television digital channels can be distributed and received upon authorization by a prepaid card system.

In another embodiment, the upgraded set-top box can be further augmented by an expansion box that is removably attachable to the upgraded set-top box. In accordance with this embodiment, the expansion box is designed with expansion slots in which expansion modules providing additional and new services can be installed. The expansion modules could be, for example, expansion cards or similar devices which can be plugged into the expansion slots to provide additional functionality.

In another embodiment, the expansion box contains an integrated power supply section that will provide power to the upgraded set-top box and the additional expansion modules that may be installed.

The upgraded and expanded set-top box when used in a two-way cable television/broadband network can now deliver new and additional services depending on the expansion modules installed. Single expansion cards or a combination of a number of cards can be installed to provide the different services that are available from the broadband network.

Further features and advantages of the present invention, as well as the structure and operation of various embodiments of the invention, are described in detail below with reference to the accompanying drawings.

### BRIEF DESCRIPTION OF THE DRAWINGS/FIGURES

The accompanying drawings illustrate the present invention and together with the description, further serve to explain the principles of the invention and to enable a person skilled in the relevant art to make and use the invention. In the drawings, like reference numbers indicate identical or functionally similar elements. Additionally, the left-most digit(s) of a reference number identifies the drawing in which the reference number first appears.

FIG. 1A provides an exemplary external front view of an upgradeable set-top box according to an embodiment of the present invention.

FIG. 1B provides an exemplary external back view of an upgradeable set-top box and attachable power adaptor according to an embodiment of the present invention.

FIG. 2 provides an exemplary block diagram of an upgradeable set-top box and its electrical functions according to an embodiment of the present invention.

FIG. 3A provides an exemplary external front view of an upgrade module for upgrading the functions of an upgradeable set-top box according to an embodiment of the present invention.

FIG. 3B provides an exemplary external back view of an upgrade module for upgrading the functions of an upgradeable set-top box according to an embodiment of the present invention.

FIG. 4 provides an exemplary block diagram of an upgrade module and its electrical functions when coupled to an upgradeable set-top box according to an embodiment of the present invention.

FIG. 5A provides an exemplary external front view of an expansion box for expanding the functions of an upgradeable set-top box according to an embodiment of the present invention.

FIG. 5B provides an exemplary external rear view of an expansion box for expanding the functions of an upgradeable set-top box according to an embodiment of the present invention.

FIG. 6 provides an exemplary block diagram of an expansion box for expanding the functions of an upgradeable set-top box according to an embodiment of the present invention.

FIG. 7 provides exemplary external views of the expansion modules used in conjunction with an expansion box according to an embodiment of the present invention.

FIGS. 8A-8B illustrate an exemplary method of upgrading the functions of an upgradeable set-top box using an upgrade module according to an embodiment of the present invention.

FIGS. 9A-9C illustrate a method of expanding the functions of an upgradeable set-top box using an expansion box according to an embodiment of the present invention.

FIGS. 10A-10B illustrate an exemplary method of expanding the functions of an expansion box according to an embodiment of the present invention.

### DETAILED DESCRIPTION OF THE INVENTION

I. Upgradeable Set-Top Box

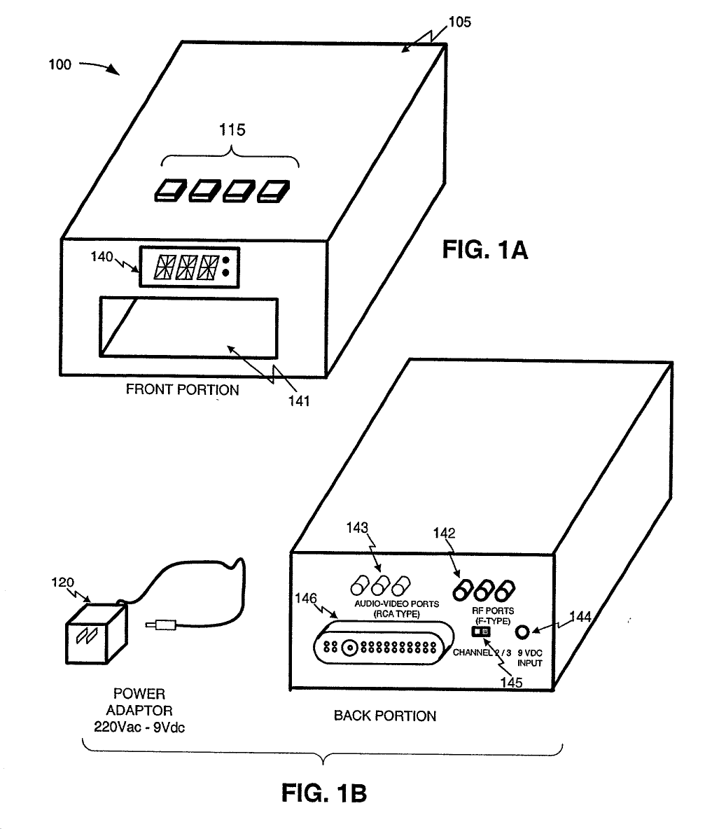

Referring to FIG. 1A, in an embodiment, the upgradeable set-top box 100 is comprised of a housing 105, a display 140, an upgrade slot 141, and one or more function access buttons 115. In an embodiment, the display 140 is a LED display and is used to visually communicate the status of the upgradeable set-top box 100 to a viewer. The upgrade slot 141 is an open area within the upgradeable set-top box 100 that is used to receive an upgrade module (described further below). The function access buttons 115 are provided for a user to selectively operate the upgradeable set-top box 100. For example, the function access buttons 115 could be used to power the upgradeable set-top box 100 on and off or tune the upgradeable set-top box 100 to different channels.

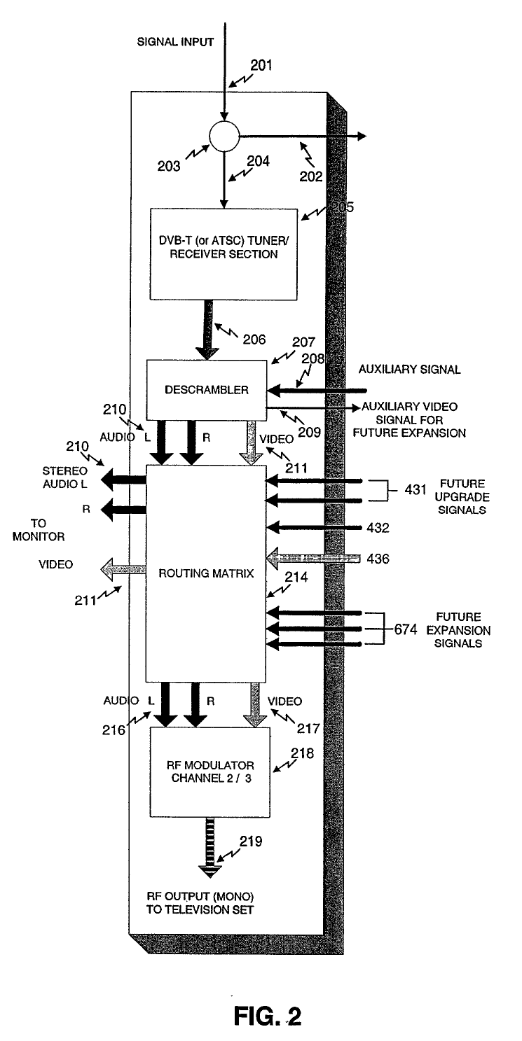

Referring to FIG. 1B, in an embodiment, the upgradeable set-top box 100 is further provided with a plurality of audio-video ports 143. The audio-video ports 143 provide the upgradeable set-top box 100 with the ability to receive and transmit audio and video signals. A number of radio frequency (RF) ports 142 are also included with the upgradeable set-top box 100. In the present embodiment, three ports are provided for antenna input, cable television input, and RF output to a television set. A power input port 144 is used to provide power to the upgradeable set-top box 100 using for example, an external power supply adaptor 120. The external power supply adaptor 120 can be acquired separately and used to power the upgradeable set-top box 100. In the present embodiment, the output of external power supply adaptor 120 is in DC form and corresponds to the voltage and power requirements of the upgradeable set-top box 100. A channel output selector 145 is used to selectively choose the channel output over which a viewer will watch the received broadcast signals using a standard broadcast television receiver. When necessary, an upgradeable set-top box expansion port 146 is available to couple the upgradeable set-top box 100 to an expansion box. Exemplary internal components of the upgradeable set-top box 100 of the present invention will now be described with reference to FIG. 2.

In an embodiment, the upgradeable set-top box 100 is further comprised of a signal splitter 203, and an upgradeable set-top box tuner/receiver section 205. The upgradeable set-top box tuner/receiver section 205 can be compliant with DVB-T, ATSC, or other standards depending on the type of technology adopted by the broadcaster. A de-scrambler 207 is provided to enable the reception of basic digital signals. A routing matrix 214 provides for the proper routing of the audio-video signals. This is particularly important when the functions of the upgradeable set-top box 100 are upgraded and/or expanded in accordance with embodiments of the present invention. More to the point, as upgraded and expanded functions are added, the electronic signals corresponding to those functions will need to be correctly routed to and from the appropriate modules.

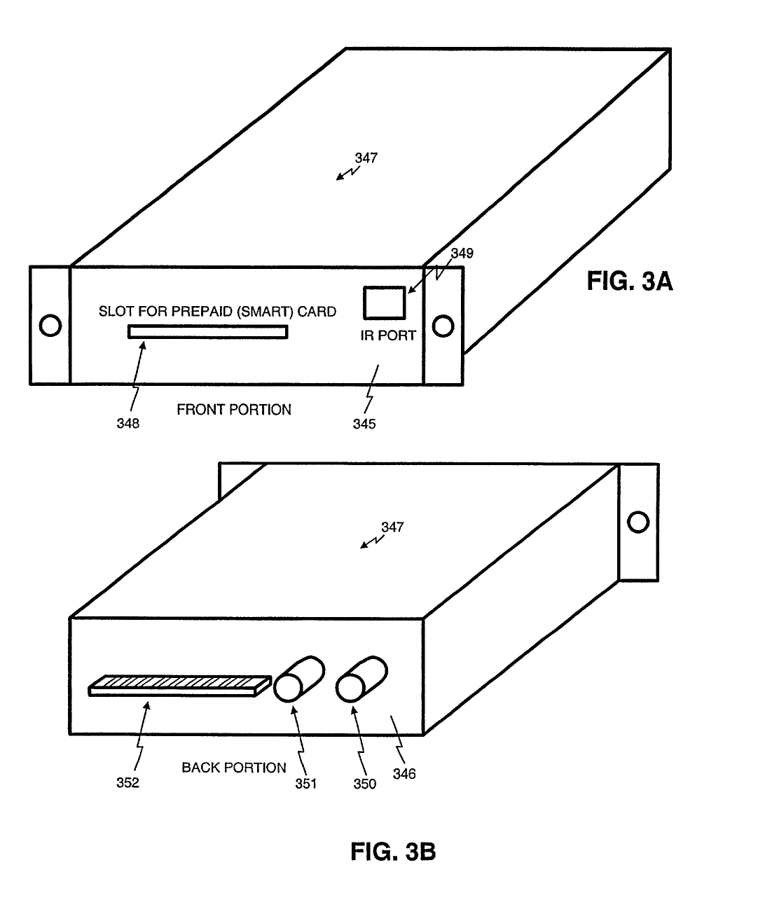

An RF modulator 218 is provided to enable the upgradeable set-top box 100 to be connected to a standard television set. In an embodiment, the RF modulator 218 is tuned to a standard television channel selected via the channel output selector 145 (FIG. 1B). In another embodiment, the RF modulator 218 can be replaced with a Phase Alternating Line (PAL) compliant counterpart as required by the end user. Additional features of the upgradeable set-top box 100 will be described further below with reference to an exemplary implementation. To continue, in accordance with another embodiment of the present invention, an exemplary upgrade module 347, will now be described with reference to FIG. 3.

II. Upgrade Module

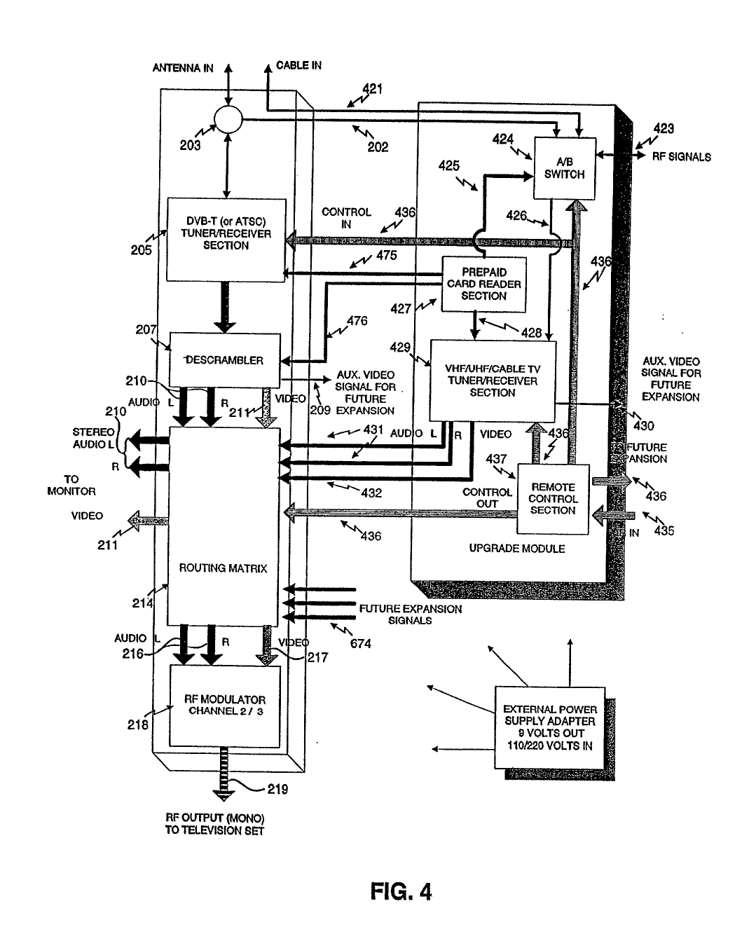

The upgrade module 347 is used to provide the upgradeable set-top box 100 with additional functions. The upgrade module 347 is provided with a smart card slot 348 on a front face or portion 345 thereof. In accordance with embodiments of the present invention, the smart card slot 348 is used to receive prepaid smart cards. An infrared (IR) port 349 is also provided on the front face 345 for wireless remote control functionality. The back face or portion 346 of the upgrade module 347 is provided with interface connectors which will mate with corresponding ports (not shown) on the upgradeable set-top box 100. In the present embodiment, the RF connectors 350 and 351 provide for the input and output of RF signals between the upgradeable set-top box 100 and the upgrade module 347. An edge connector 352 provides for the exchange of power, audio, video, and other non-RF signals exchanged between the upgrade module 347 and the upgradeable set-top box 100. Exemplary internal components of the upgrade module 347 will now be described with reference to FIG. 4.

In an embodiment, the upgrade module 347 is designed to be inserted into the upgradeable set-top box 100. In this way, additional functionality for the combined devices is achieved. In the present embodiment, the upgrade module 347 includes an A/B switch 424 that can select what input the combined devices will process. The A/B switch 424 is also used for exchanging RF signals 423 with an expansion box used to expand the functionality of upgradeable set-top box 100. A prepaid card reader section 427 allows for a user of the combined upgradeable set-top box 100 and upgrade module 347 to access prepaid functions via the combined devices. The prepaid card reader section 427 is provided with computer programs (also called computer control logic) to determine the level of service the combined upgradeable set-top box 100 and upgrade module 347 can receive based on the amount of credit available on a removable SIM (Subscriber Identity Module) card to be inserted. An upgrade module tuner receiver section 429 is also provided. In the present embodiment, the upgrade module tuner receiver section 429 is a VHF/UHF/Cable TV tuner. The upgrade module tuner receiver section 429 allows the combined upgradeable set-top box 100 and upgrade module 347 to receive off-air VHF and UHF television signals as well as cable television channels. A remote control section 437 and the corresponding infrared pickup port 349 provide remote control functions to the upgradeable set-top box 100. The remote control section 437 receives command signals from a remote control and transmits corresponding signals to control the upgradeable set-top box tuner/receiver section 205, routing matrix 214, A/B switch 424, and the upgrade module tuner/receiver section 429. The remote control section 437 is further useful for accessing and controlling the additional functions provided by attaching the upgradeable set-top box 100 to an expansion box (described in detail further below). Once attached, control signals 436 can be transmitted to the expansion box. Likewise, infrared signals 435 can be received via an infrared port. Additional features of the upgrade module 347 will be described further below with reference to an exemplary implementation.

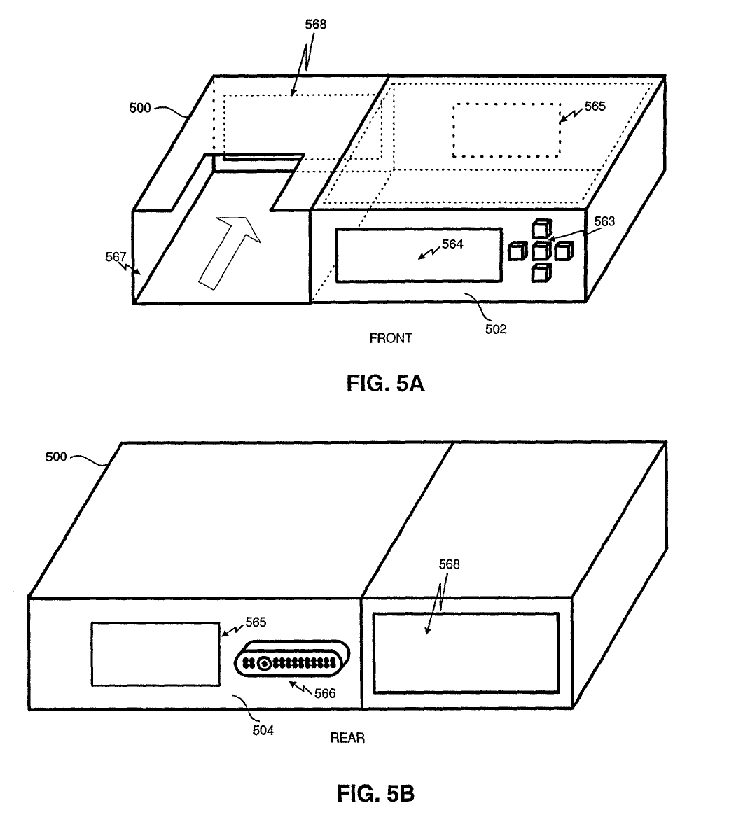

As the entertainment and information needs of the viewer become more sophisticated, an expansion box 500 is designed to be removably attachable to the upgradeable set-top box 100. In this way, additional functionality may be achieved without making the upgradeable set-top box 100 obsolete. An exemplary external view of an expansion box 500, configured in accordance with embodiments of the present invention, will now be described with reference to FIGS. 5A and 5B.

III. Expansion Box

FIG. 5A shows a front perspective view of an embodiment of the expansion box 500. Expansion box 500 has an insert slot 567 provided on a front face 502. In the present embodiment, the insert slot 567 is a loading bay/slot. In this way, the expansion box 500 can be removably connected to the upgradeable set-top box 100 by sliding the upgradeable set-top box 100 into the insert slot 567 of the expansion box 500. By slidably attaching the expansion box 500 and the upgradeable set-top box 100, mechanical stability is achieved. After reading this disclosure, a person skilled in the relevant arts will recognize alternative methods of attaching the expansion box 500 and the upgradeable set-top box 100 without departing from the spirit and scope of the present invention.

The expansion box 500 is further provided with a display 564 on the front face 502. The display 564 is used to show the status of the expansion box 500. In an embodiment, the display 564 is a wide-screen LCD display. Expansion box function access buttons 563 are provided on front face 502 for menu navigation. Together, the display 564 and the expansion box function access buttons 563 allow different services to be accessed and any required set-up options to be inputted.

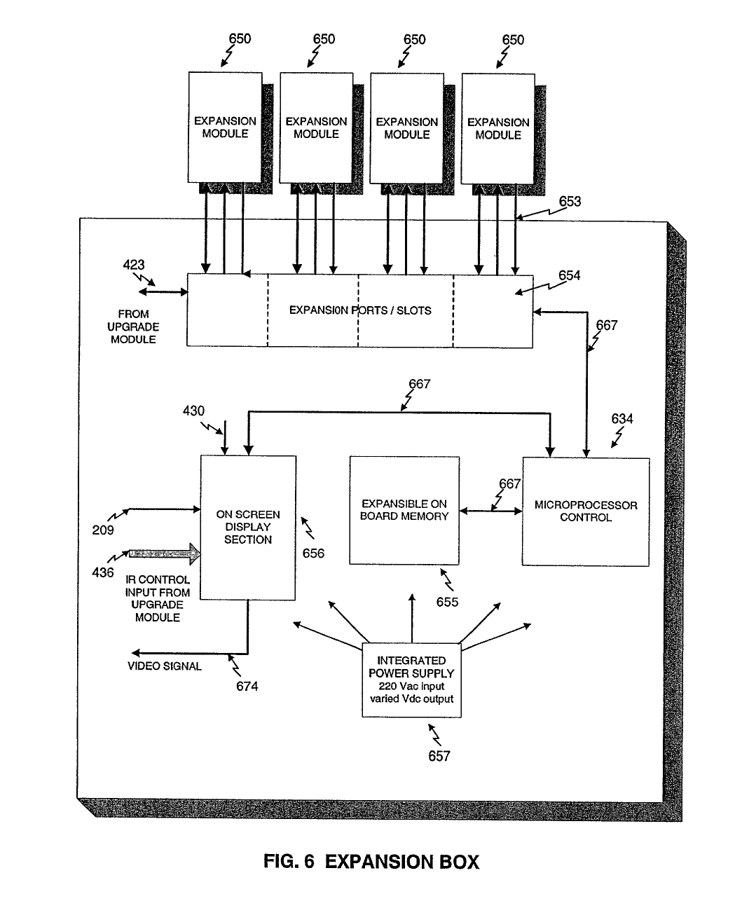

An access panel 568 provides accessibility to the ports of the upgradeable set-top box 100 when attached to a rear face 504 of the expansion box 500. Further, expansion box 500 has a connection port 566 on the rear face 504 for connecting to the expansion port 146 on the upgradeable set-top box 100. An expansion module access panel 565, also disposed on the rear face 504, can be removed to expose the ports of one or more expansion modules installed inside the expansion box 500. Further details of the expansion box 500 will now be provided with reference to FIG. 6.

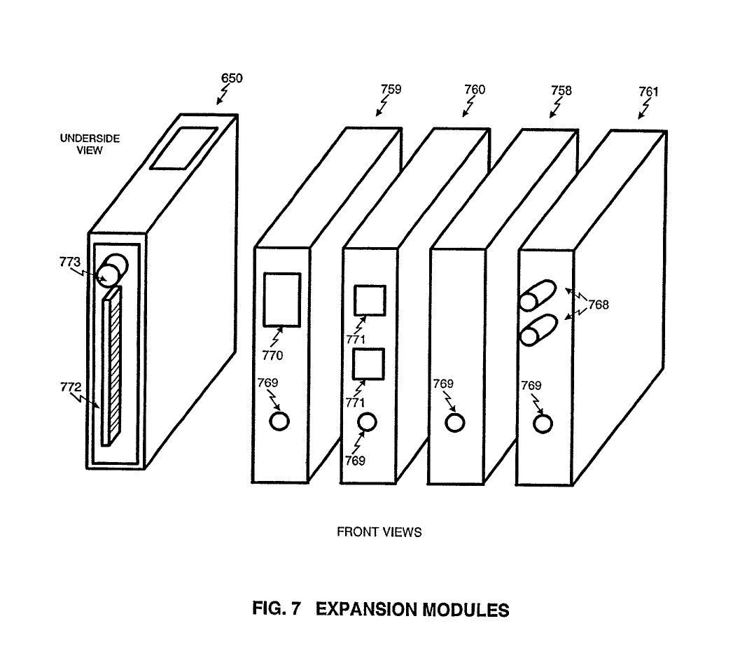

In an embodiment, the expansion box 500 is provided with one or more expansion slots 654. A plurality of bus connections 653 are used for exchanging communications among the expansion modules 650 and other set-top box components, such as for example, a microprocessor 634. The expansion modules 650 are inserted into one of the expansion slots 654 to expand the functions of the expansion box 500 and upgradeable set-top box 100. Self-terminating RF splitters (not shown) are used to detect when an expansion module 650 is present within one of the expansion slots 654. In the present embodiment, the self-terminating RF splitters are terminated to 75 ohms when no expansion module 650 is inserted. The expansion modules 650 are described in further detail below with respect to FIG. 7.

An on-screen display section 656 provides on-screen display functionality to the combined upgradeable set-top box 100 and expansion box 500. The on-screen display section 656 is responsible for composing information to be displayed on a monitor or television screen. Such information can include for example, the digital or analog channel that the box is tuned to, an electronic program guide, web pages, and other related information. In the present embodiment, the on-screen display section 656 receives as its input, the auxiliary video signal 430 which originates from the upgrade module 347 and the auxiliary video signal 209 from the descrambler 207. The microprocessor 634 is added to provide computer program logic to the combined upgradeable set-top box 100 and expansion box 500. The computer program logic of the microprocessor 634 and its ability to control the additional functionality provided by the expansion modules 650 is supported by the on-board expansible memory 655. An integrated power supply 657 is also included. In this way, power can be provided to the expansion box 500, the upgradeable set-top box 100, and the upgrade module 347. The present embodiment would then allow for external power supply adaptor 120 to be discarded or used for other purposes.

FIG. 7 illustrates the different expansion modules 650 that could be used with the expansion box 500 in accordance with embodiments of the present invention.

An internet-over-television module 758 provides internet browsing using only a television set and an optional IR wireless keyboard.

A cable modem module 759 enables the combined expansion box 500 and upgradeable set-top box 100 to perform cable modem functions. An Ethernet port 770 is provided for connection to a personal computer.

A telephony module 760 provides telephone functionality to the combined expansion box 500 and upgradeable set-top box 100. Two telephone ports 771 are provided for connection to standard analog telephone sets.

A digital multi-channel audio module 761 enables the combined expansion box 500 and upgradeable set-top box 100 to receive multi-channel stereophonic audio signals and connect them to a stereophonic component audio system. To facilitate such a connection, stereo RCA jacks 768 are provided.

In the present embodiment, the underside portion of the expansion module 650 is designed with connectors that will mate with corresponding ports on the expansion box 500. Specifically, an RF connector 773 enables the transfer of RF signals from the expansion box 500 into the expansion module 650. An edge connector 772 provides for the interchange of non-RF signals between the expansion module 650 and the expansion box 500. Further, in the present embodiment, each expansion module 650 (for example, modules 758, 759, 760, and 761) are provided with a dual color led 769 to indicate operation status.

The above described modules are meant for example only, and not limitation. More generally, the bus architecture of the expansion box 500 would enable further expansion modules of specific functions to be installed in the future. One such future expansion module 650 could be a modular card that would provide recording of received television programs on a built in RAM drive. Video of more than two hours can be stored in an appropriate storage medium in the modular card and can be played back later. Upon reading this disclosure, a person of ordinary skill in the relevant arts will recognize that this and other future broadband-based applications or services yet to be developed can be included by designing the compatible expansion card to be attached to the expansion box 500. This flexibility inherent in the present invention makes the combined expansion box 500 and upgradeable set-top box 100 a very versatile device.

IV. Exemplary Method for Upgrading and Expanding

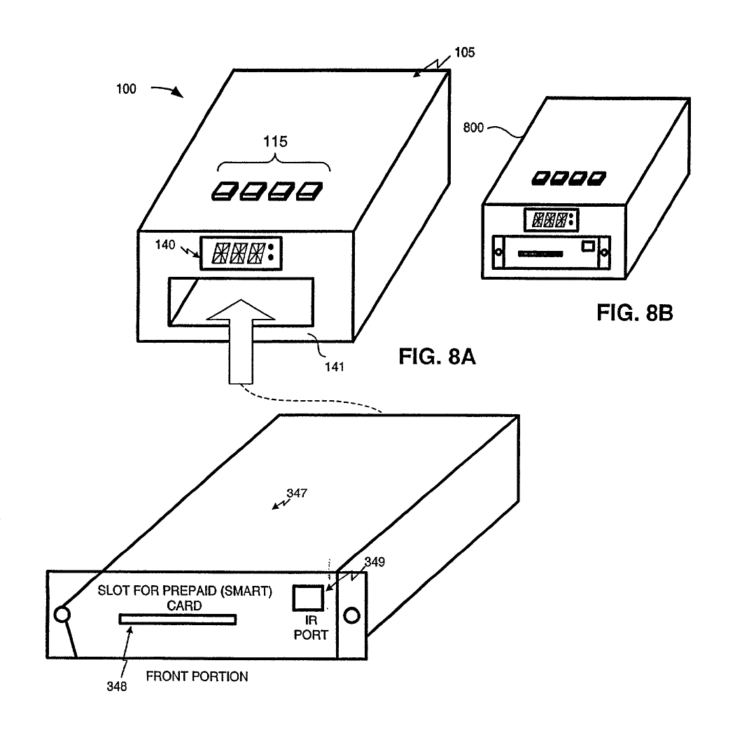

FIGS. 8A-10 provide an exemplary illustration of a method for upgrading and expanding the functionality of the upgradeable set-top box 100 in accordance with an embodiment of the present invention.

First, as shown in FIG. 8A, an upgrade module 347 is inserted into the upgrade slot 141 of the upgradeable set-top box 100. This produces an upgraded set-top box 800 as shown in FIG. 8B. The upgrade module 347 provides the upgraded set-top box 800 with additional functionality previously unavailable in the upgradeable set-top box 100. In accordance with embodiments of the present invention, this increased functionality is realized without having to replace the upgradeable set-top box 100. As the information and viewing needs of the user become more sophisticated, the functionality of the upgraded set-top box 800 can be further enhanced using the expansion box 500.

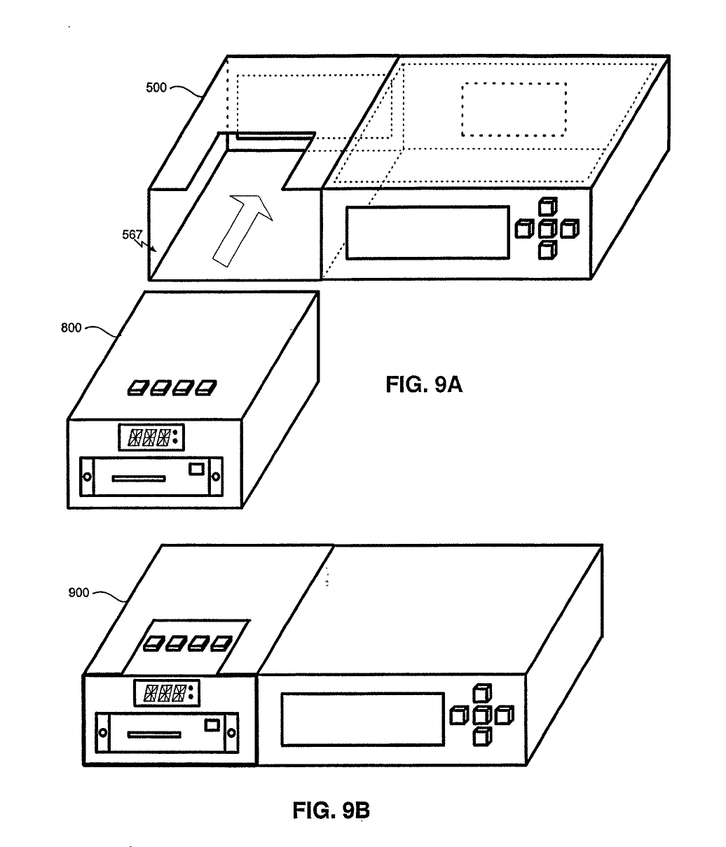

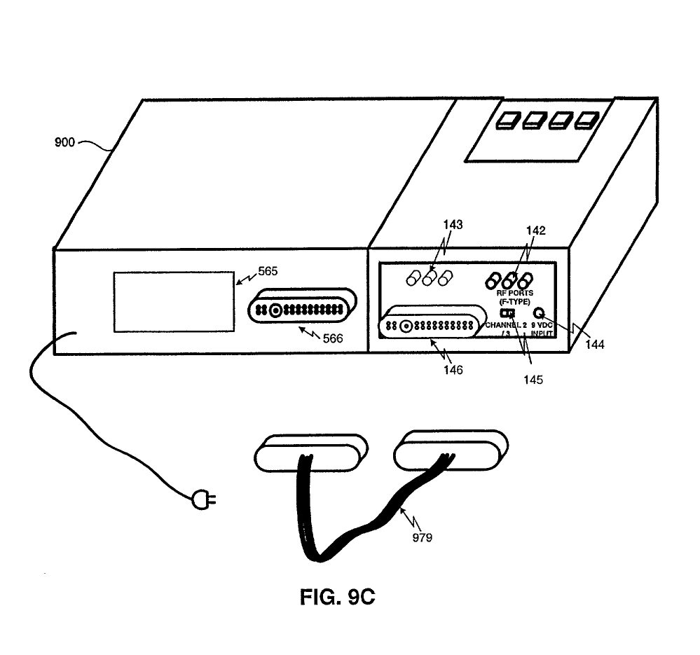

Referring to FIG. 9A, the upgraded set-top box 800 is shown being inserted into the insert slot 567 of the expansion box 500. This produces an upgraded and expanded set-top box 900 as shown in FIG. 9B. As illustrated in FIG. 9C, the access panel 568 is removed to expose the audio-video ports 143, RF ports 142, channel output selector 145, power input port 144, and expansion port 146.

Once the upgraded set-top box 800 has been inserted into the expansion box 500, a connector 979 is used to attach expansion port 146 and connection port 566. In an embodiment, the connector 979 is a multi-core jumper cable. The connector 979 is used to isolate the RF signals as well as to control the audio and video signals being exchanged between the expansion box 500 and upgraded set-top box 800. In yet another embodiment, the functionality of the upgraded and expanded set-top box 900 can be further enhanced by expanding the features of the expansion box 500.

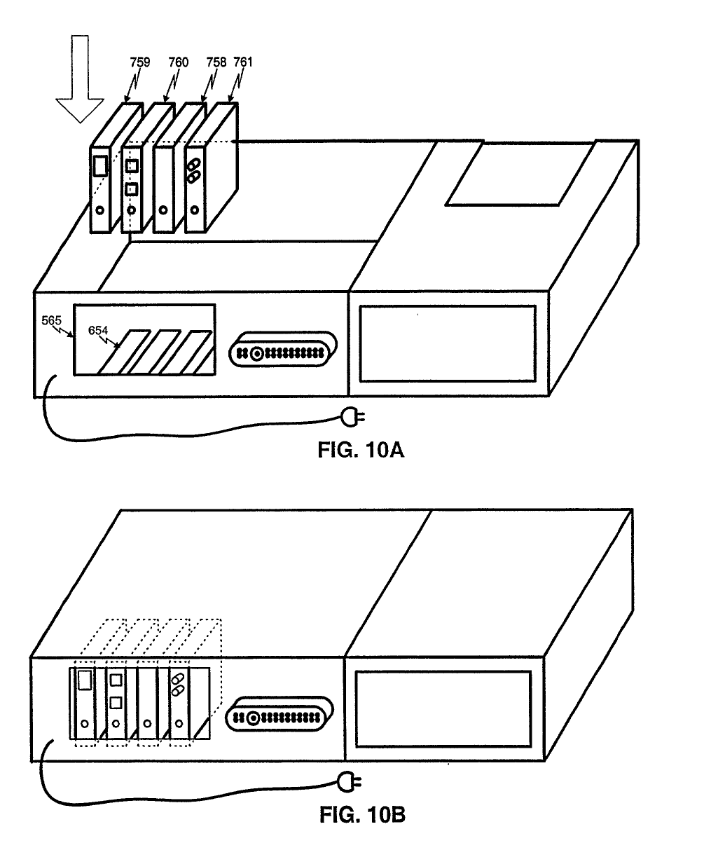

FIGS. 10A and 10B provide an exemplary illustration of a method for expanding the functionality of the expansion box 500 in accordance with an embodiment of the present invention. The expansion module access panel 565 is opened to allow a peripheral device (for example, telephones, stereophonic components, and computers) to be connected to the expansion module 650 once the expansion module has been inserted.

Next, an expansion module 650 (for example, module 758, 759, 760, or 761) is inserted into one of the expansion slots 654. In the present embodiment, four expansion modules (758, 759, 760, and 761) are shown in the expansion box 500. Upon reading the disclosure, a person skilled in the relevant arts would recognize that one or more of the expansion modules can be added as needed. In this way, the functionality expansion can be scaled according to the needs and financial resources of the viewer. Continuing, once an expansion module 650 is inserted, the electrical output of the RF splitter would be adjusted to reflect the presence of the expansion module 650. Once connected, the upgraded and expanded set-top box 900 can be set-up to use the newly added function.

With the expansion box 500 attached to the upgraded set-top box 800, the viewer can take advantage of the different types of broadband services that can be made available through the single box design of the present invention. Hence, the investment in the upgradeable set-top box is maximized. For example, the Internet-Over-TV expansion module 758 can be added to enable the viewer to surf into World Wide Web pages with a built-in browser. In an embodiment, the browser is designed to be download upgrade-able. The browser allows a cable television headend-based server to deliver internet content to the subscriber to be viewed on the subscriber's television set. Further, with the use of a wireless keyboard via the infrared receiver port of the remote control, email downloading can be made possible using memory cached on the service provider's servers. Likewise, the remote control further enables the viewer to click hypertext links on the television screen. Consequently, the expansion module 650 should be compatible with the cable headend system to provide two-way communication over the air.

In accordance with the present embodiment, a cable modem expansion module 759 could also be added. In the present embodiment, the cable modem expansion module 759 is a DOCSIS compliant device enabled for use with a personal computer while the upgraded and expanded set-top box 900 is used to receive analog or digital television signals. Accordingly, corresponding output ports are included on the expansion modules or cards to be connected to a personal computer for internet communications. By maximizing the available bandwidth in the broadband network that the combined upgraded set-top box and expansion box are connected to, higher download speeds are obtainable.

An IP telephony expansion module 760 can be installed to meet the need for a second or third telephone line. IP Telephony enables the upgraded and expanded set-top box 900 to perform the functions of a network interface card providing telephone functionality. Through IP transmission, voice packets can be sent and received through the upgraded and expanded set-top box 900, thereby providing additional functionality to the device. Two telephone line ports are provided where analog telephone sets can be connected. In accordance with this embodiment, the computer program logic needed to convert the analog telephone signals is designed into the ILP telephony expansion module 760. Similar to the cable modem, this expansion module can operate independently from the television reception functions of the upgraded and expanded set-top box 900.

Lastly, the multi-channel digital stereo audio expansion module 761 can be designed to provide for the reception of multiple channels of stereophonic audio which can be monitored in the television set or connected to an external sound/speaker system. More specifically, multi-channel digital audio enables the upgraded and expanded set-top box 900 to function as a multiple channel digital stereo audio receiver that converts received digital audio signals into baseband stereo audio ready to be fed to an audio system. Given the wide bandwidth available in the broadband system and advances in data compression techniques, additional pay audio channels can be made available to subscribers who have varied musical tastes.

Likewise, additional audio information can be displayed on the television set which includes but is not limited to artist information, song, lyrics and purchase information. Still further, developments in Bluetooth™ wireless technology can be implemented to minimize the use of connecting cables between the upgraded and expanded set-top box 900 and a conventional audio stereo system. Bluetooth™ wireless technology is a wireless communications standard promoted by a trade association operating under the name Bluetooth SIG, Inc.

It is further emphasized that future broadband services yet to be developed can be incorporated into the expansion box 500 by designing the corresponding compatible expansion module. The upgrade path from upgradeable set-top box 100 to upgraded set-top box 500 to upgraded and expanded set-top box 900 to modular card-based service expansions and similar advancements provides for a gradual upgrade of the set-top box based on the capacity of the viewer/subscriber to spend for his entertainment and/or information needs. An exemplary implementation of the present invention will now be described with reference to the above described figures.

V. Exemplary Implementation

Referring again to FIG. 2, input signals 201 are received by an external antenna and are then fed into the upgradeable set-top box 100. The signal splitter 203 divides the signals into two signal streams. A first signal stream 202 is initially terminated for future feeding to the upgrade module 347. A second signal stream 204 is fed to the upgradeable set-top box tuner/receiver section 205 of the upgradeable set-top box 100.

The upgradeable set-top box tuner/receiver section 205 generates a tuner output signal 206. In the present embodiment, the tuner output signal is an encrypted digital signal. The tuner output signal 206 is next fed to the de-scrambler section 207 which converts the encrypted digital signal into a standard stereophonic audio signal 210 and baseband video signal 211. An auxiliary video signal 209 and an auxiliary signal 208 are initially terminated for future use when the upgradeable set-top box 100 has been upgraded.

The standard stereophonic audio signal 210 and the baseband video signal 211 are then fed to the routing matrix 214. The routing matrix 214 will determine how the signals are routed between the inputs and outputs. When the upgrade module 347 is not yet in place, the default routing input of the routing matrix 214 shall be the stereophonic audio signal 210 and the baseband video signal 211 from the descrambler 207.

The routing matrix 214 will output the stereophonic audio signal 210 and baseband video 211. These outputs can be fed through RCA-type output ports to an external television monitor having audio and video inputs at the back of the monitor. Signals 431, 432, 436, and 674 are initially terminated for future use once the upgradeable set-top box 100 has been upgraded or expanded. These signals will be described in further detail below.

Continuing with the present description, another set of stereophonic audio signals 216 and baseband video 217 outputs are fed to the RF Modulator 218. The RF Modulator 218 then converts these signals into an RF modulated signal 219. The RF modulated signal 219 can serve as input to the antenna input of a television set through F-type RF ports found at the back of the appliance. This is useful for older model broadcast televison sets that do not have RCA-type audio and video inputs.

According to the present embodiment, in non-upgraded form, the upgradeable set-top box 100 is capable of receiving digital television signals and converting these signals into a compatible form that can be fed into a video monitor and/or television set. With minimal circuit components and practical absence of features, the upgradeable set-top box 100 is expected to cost within the reach of middle class television viewers.

Referring again to FIG. 4, the next stage of upgrade for the upgradeable set-top box 100 shall be the insertion of the upgrade module 347 into the upgrade slot 141 of the upgradeable set-top box 100. This produces the upgraded set-top box 800. In the present embodiment, the upgrade module 347 can receive input from two possible sources: the first signal stream 202 or a cable input 421. Both inputs are attached to the A/B switch 424 in order to facilitate the selection and isolation of the two signals. In an embodiment, the A/B switch can be electronically controlled through control signals 425 generated from the prepaid card reader section 427. Depending on the card inserted into the card reader section, the cable input signal can be disabled thereby preventing reception of cable television signals. The A/B switch output 426 is fed to the upgrade module tuner/receiver section 429.

The upgrade module tuner/receiver section 429 generates a tuner section audio signal 431 and video signal 432. The tuner section audio signal 431 and video signal 432 are each fed to the routing matrix 214 of the upgraded set-top box 800. When analog reception is selected, the upgraded set-top box 800 will route the signal to the monitor and/or television outputs of the upgraded set-top box 800.

In the present embodiment, the upgraded set-top box 800 shall have remote control features for the convenience of the viewer. Furthermore, with the analog tuner of the upgrade module 347, all VHF, UHF and Cable Television channels can now be received by the box. Hence, there would be a single remote controller that can be used to watch either the digital or analog signals. Furthermore, the inclusion of the prepaid card reader section 427 provides prepaid functions to the upgraded set-top box 800. Accordingly, prepaid signals 428, 475, and 476 are used to authorize cable television services and digital terrestrial services on a prepaid basis. The inclusion of the upgrade module 347 further enables the upgraded set-top box 800 to receive wireless signals 435 from a wireless keyboard via the infrared ports also utilized by the remote control. In response to receiving the wireless signals, the remote control section 437 generates corresponding control signals 436 for input to the appropriate component (for example, the routing matrix 214, the upgradeable set-top box tuner/receiver section 205, upgrade module tuner section 429, the A/B switch 424, or an on screen display section 656). A control signal 436, RF signals 423, and auxiliary video signal 430 are initially terminated until the upgraded set-top box 800 has been joined with the expansion box 500.

As the entertainment and information needs of the viewer become more sophisticated, the expansion box 500 can be attached to the upgraded set-top box 800. In this way, additional functionality is achieved without making the upgradeable set-top box 100 obsolete. The expansion box 500 makes the integrated/combined boxes capable of accepting additional expansion modules for other value added services such as television internet, cable modems, cable telephone over IP and multi-channel digital audio reception.

Referring again to FIG. 6, RF signals 423 originating from the upgrade module 347 are split and distributed among the appropriate expansion modules 650 via the bus 653.

The on-screen display section 656 receives as input, the auxiliary video signal 430 from the upgrade module 347 and the auxiliary video signal 209 from descrambler 207. The on-screen display section 656 is further capable of receiving as input, the control signal 436 from the remote control section 437 initially terminated at the upgrade module 347.

The microprocessor 634 provides overall control over the different sections within the expansion box 500. Control lines 667 are used to exchange control information between the microprocessor 634 and the expansible on-board memory 655, the on-screen display section 656 and the expansion modules 650 via the expansion slots 654 and bus connections 653.

On-screen display section 656 next produces the video signal 674. The video signal 674 is then fed back to the routing matrix 214 for eventual switching to the designated television or stereo system output.

VI. Conclusion

While various embodiments of the present invention have been described above, it should be understood that they have been presented by way of example only and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A set-top box for converting a signal, the set-top box comprising:
(a) a housing, including
(i) an input port for receiving an input signal,
(ii) an output port for transmitting an output signal,
(iii) an upgrade slot formed within a first side of said housing, and
(iv) an expansion port;
(b) a tuner disposed within said housing, wherein said tuner converts said input signal to said output signal;
(c) an upgrade module formed to removably fit within said upgrade slot; and
(d) an expansion box removably attachable to said housing, wherein said expansion box has one or more expansion slots formed therein for receiving a removable expansion module.

2. The set-top box of claim 1, further comprising an integrated power supply for supplying power to said housing, said upgrade module, and said expansion box.

3. The set-top box of claim 1, wherein said removable expansion module provides additional functionality to said set-top box.

4. The set-top box of claim 1, wherein said removable expansion module is an Internet-Over-TV expansion module.

5. The set-top box of claim 4, wherein said Internet-Over-TV expansion module enables a user of the set-top box to surf the World Wide Web.

6. The set-top box of claim 1, wherein said removable expansion module is a cable modem expansion module.

7. The set-top box of claim 1, wherein said removable expansion module is an IP Telephony expansion module.

8. The set-top box of claim 1, wherein said removable expansion module is a multi-channel digital stereo audio expansion module.

9. An upgradeable set-top box, the upgradeable set-top box comprising:
(a) a housing;
(b) a plurality of input ports for receiving an input signal;
(c) a plurality of output ports for transmitting an output signal;
(d) an upgrade module;
(e) an upgrade slot formed within a first side of said upgradeable set-top box for receiving said upgrade module;
(f) an expansion box, removably attachable to said housing, wherein said expansion box has one or more expansion slots formed therein for receiving a removable expansion module; and
(g) an expansion port for connecting said housing and said expansion box.

10. The upgradeable set-top box of claim 9, further comprising a signal splitter for dividing said input signal into a basic signal and an upgrade signal.

11. The upgradeable set-top box of claim 9, further comprising a descrambler comprised of a primary audio output, a primary video output, an auxiliary upgrade input, and an auxiliary upgrade video output.

12. The upgradeable set-top box of claim 9, wherein said upgrade module provides additional functionality to said upgradeable set-top box.

13. The upgradeable set-top box of claim 12, wherein the additional functionality is the ability to selectively receive a plurality of input signals using an A/B switch.

14. The upgradeable set-top box of claim 9, wherein said upgrade module is comprised of a smart card reader.

15. The upgradeable set-top box of claim 14, wherein said smart card reader provides said set-top box with the additional functionality of processing prepaid functions.

16. The upgradeable set-top box of claim 9, wherein said upgrade module is comprised of a multiple signal tuner.

17. The upgradeable set-top box of claim 16, wherein said multiple signal tuner provides said set-top box with the additional functionality of receiving off-air VHF and UHF television signals, and cable signals.

18. The upgradeable set-top box of claim 9, wherein said upgrade module is comprised of a remote control section.

19. The upgradeable set-top box of claim 18, wherein said remote control section provides said upgradeable set-top box with the additional functionality of remotely operating said upgradeable set-top box.

20. The upgradeable set-top box of claim 18, wherein said remote control section provides said upgradeable set-top box with the additional functionality of receiving signals from a wireless keyboard via infrared ports.

21. The upgradeable set-top box of claim 9, wherein said expansion box is provided with a plurality of splitters that indicate the presence of said removable expansion module.

22. A method of upgrading a set-top box, the method comprising the steps of:
(a) inserting an upgrade module into an upgrade slot formed within a first side of the set-top box; and
(b) attaching an expansion box to the set-top box, wherein said expansion box has one or more expansion slots for receiving a removable expansion module, such that said upgrade module and said expansion box provide additional functionality to the set-top box.
